(19) United States
(12) Patent Application Publication
(10) Pub. No.: US 2026/0145884 A1
(43) Pub. Date: May 28, 2026

(54) DEVICE FOR DETERMINING THE ELONGATION OF TWO CHAINS AND ASSOCIATED TWIN-CHAIN CONVEYOR AND METHOD

(71) Applicant: AKTIEBOLAGET SKF, GOTEBORG (SE)

(72) Inventor: Phillip HEWITT, Utrecht (NL)

(21) Appl. No.: 19/380,061

(22) Filed: Nov. 5, 2025

(30) Foreign Application Priority Data
Nov. 22, 2024 (DE) 102024211209.7

(51) Int. Cl. B65G 43/02; B65G 17/12

(52) U.S. Cl. CPC B65G 43/02; B65G 17/126; B65G 2203/0275; B65G 2203/043

(57) ABSTRACT

A method for determining characteristics of a first chain and a second chain of a matched pair of parallel chains of a twin-chain conveyor includes driving the chains at a predetermined speed and determining a first time interval between first and second pins of the first chain passing a first sensor and a second time interval between first and second pins of the second chain passing a second sensor both when the conveyor is loaded (a loaded time interval) and unloaded (an unloaded time interval). Also determining a difference between the respective loaded time intervals and the unloaded time intervals as a degree of elongation of each chain and a difference between the loaded time interval of the first chain and a loaded time interval of the second chain as a differential elongation of the conveyor.

### CROSS-REFERENCE

This application claims priority to German patent application no. 10 2024 211 209.7 filed on Nov. 22, 2024, the contents of which are fully incorporated herein by reference.

### TECHNOLOGICAL FIELD

The present disclosure is directed to the determination of the wear. More particularly, the disclosure is directed to a method and a device for determining the elongation of chains running in parallel matched pairs of a twin-chain conveyor.

### BACKGROUND

It is known that the elongation of the chains is representative of the wear of the chains. Moreover, chains running in parallel in matched pairs of a twin-chain conveyor need to have the same length for the twin-chain conveyor to operate correctly, efficiently but mostly safely. If one of the chains is worn, all the conveyor system is disrupted. It is therefore important to monitor chain wear and to the compare the two chains.

When the value of the elongation of at least one chain of the twin-chain conveyor has reached a predetermined value, the chain is worn and needs to be replaced to avoid failure and breakage of the chain. Moreover, some operations on the twin-chain conveyor must be performed when the comparison between the values of the elongation of the two chains has reached another predetermined value.

The values of the elongation of the two chains are determined by measuring the distance between two chain pins arranged on each chain and comparing the measured distance with the distance between two comparable pins of a new chain. To measure the distance between two chain pins on each chain, the twin-chain conveyor needs to be shut down and the distance needs to be physically measured with a tool. In order to plan preventive maintenance operations, the values of the elongation of the chains need to be determined many times. As the twin-chain conveyor is stopped each time when the values of the elongation of the chains are determined, the productivity of the twin-chain conveyor is decreasing.

### SUMMARY

Consequently, the present disclosure provides a method to monitor the wear of the chains of a twin-chain conveyor without stopping the twin-chain conveyor. A method for determining the elongation of a first chain and a second chain running in parallel in a matched pairs of a twin-chain conveyor is proposed.

The method includes a first set of actions performed during an initializing step and a second set of actions performed during a conveying step. The first set of actions includes, while the chains of the twin-chain conveyor are driven by at a constant speed by a driving mechanism: detecting a first instant of passage of a first target element arranged at a first end of a first chain pin of the first chain in front of a first sensor, detecting a first instant of passage of a first target element arranged at a first end of a first chain pin of the second chain in front of a second sensor, detecting a second instant of passage of a second target element arranged at a first end of a second chain pin of the first chain in front of the first sensor, and detecting a second instant of passage of a second target element arranged at a first end of a second chain pin of the second chain in front of the second sensor. The method also includes determining, for each of the first and second chains, a duration between the first instant of passage and the second instant of passage, the duration being a reference duration.

The conveying step occurs after the initializing step and includes, while driving the twin-chain conveyor conveys material at the predetermined speed: detecting a third instant of passage of the first target element of the first chain in front of the first sensor, detecting a third instant of passage of the first target element of the second chain in front of the second sensor, detecting a fourth instant of passage of the second target element of the first chain in front of the first sensor, and detecting a fourth instant of passage of the second target element of the second chain in front of the second sensor. The method also includes determining, for each of the first and second chains, the duration between the third instant of passage and the fourth instant of passage, the duration being a first duration, determining the value of the elongation of each of the first and second chains from the associated first duration and the associated reference duration, and comparing the value of the elongation of the first chain with the value of the elongation of the second chain and establishing a differential elongation.

The method allows automated continuous determination of the elongation of each chain to predict the wear of the chains without requiring physical measurement of the chains so that the twin-chain conveyor does not to be shut down and operatives do not need to physically measure the chains. The prediction of the wear of the chains enables maintenance operations to be planned for the chains thereby reducing risk of failure of the chains and reducing risk of breakage of the chains which may lead to damage to the twin-chain conveyor or injuring workers. Advantageously, the twin-chain conveyor does not convey material during the initialization step.

In one embodiment, on each of the first and second chains, the first chain pin and the second chain pin are immediately adjacent to one another.

Advantageously, the value of the elongation of the first chain is equal to:

$$VE 1 = \frac{D 1 - Dref 1}{Dref 1}$$

where D1 is the associated first duration and Dref1 is the associated reference duration, and

the value of the elongation of the second chain is equal to:

$$VE 2 = \frac{D 2 - Dref 2}{Dref 2}$$

where D2 is the associated first duration and Dref2 is the associated reference duration.

In one embodiment, when at least one of the determined value of the elongation of the chains is equal to at least one predetermined alert value of the elongation of the first or second chain and/or when the differential elongation is equal to at least one predetermined warning value, the method is delivering a chain alert and/or a warning signal to warn for potential failures of the twin-chain conveyor.

Advantageously, the first target element of the first chain pin of the first chain comprises a first magnet insert, the second target element of the second chain pin of the first chain comprises a second magnet insert, the first target element of the first chain pin of the second chain comprises a third magnet insert, the second target element of the second chain pin of the second chain comprises a fourth magnet insert, and the sensors are Hall effect sensors.

In one embodiment, the first and second magnets inserts each comprise a through hole, a screw passing through the through hole of the first and second magnets inserts and being engaged in a tapered hole of the first end of the first and second chain pins, and the third and fourth magnets inserts each comprise a through hole, a screw passing through the through hole of the third and fourth magnets inserts and being engaged in a tapered hole of the first end of the first and second chain pins.

According to another aspect, a device for determining the elongation of two first and second chains running in parallel matched pairs of a twin-chain conveyor is provided.

The device comprises a first target element arranged at a first end of a first chain pin of the first chain, a first target element arranged at a first end of a first chain pin of the second chain, a second target element arranged at a first end of a second chain pin of the first chain, and a second target element arranged at a first end of a second chain pin of the second chain. The device also includes a first sensor corresponding to the first chain and configured to detect the passage of the first target element and the second target element, and a second sensor corresponding to the second chain and configured to detect the passage of the first target element and the second target element, when the chains are driven by driving means of the twin-chain conveyor. The device also includes first, second and third determining means. The first determining means is configured to determine, for each of the first and second chains, a reference duration between a first instant of passage of the first target elements in front of the sensors and a second instant of passage of the second target elements in front of the sensors and a first duration between a third instant of passage of the first target elements in front of the sensors and a fourth instant of passage of the second target elements in front of the sensors. The second determining means is configured to determine the value of the elongation of each of the first and second chains from the associated first duration and the associated reference duration determined by the first determining means, and the third determining means is configured to compare the value of the elongation of the first chain with the value of the elongation of the second chain and establishing a differential elongation.

The comparison of the values of the elongation of the first and second chains makes it possible to evaluate the state of the twin-chain conveyor and to know what the difference is between the state of the first chain and the state of the second chain.

Advantageously, the device comprising warning means configured to deliver a warning signal to warn for potential failures of the twin-chain conveyor when the differential elongation is equal to at least one predetermined warning value and to deliver a chain alert when at least one of the determined value of the elongation of the chains is equal to at least one predetermined alert value of the elongation of the first or second chains.

According to another aspect, a twin-chain conveyor is provided. The twin-chain conveyor comprises a first and a second chains running in parallel matched pairs, each including a plurality of chain pins and a device as defined above. The first target elements are arranged at a first end of a first chain pin of the plurality of chain pins and the second target elements are arranged at a first end of a second chain pin of the plurality of chain pins.

### BRIEF DESCRIPTION OF THE DRAWINGS

The present disclosure and its advantages will be better understood by studying the detailed description of specific embodiments given by way of non-limiting examples and illustrated by the appended drawings on which:

FIG. 1 is a perspective view of a twin-chain conveyor according to an embodiment of the present disclosure.

FIG. 2 is a top plan view of portions of two chains of the twin-chain conveyor of FIG. 1.

FIG. 3 is a longitudinal cross section of one of the pins of the first chain of the twin-chain conveyor of FIGS. 1 and 2.

FIG. 4 illustrates schematically an example of a method for determining the elongation of the chains of the twin-chain conveyor according to the disclosure.

### DETAILED DESCRIPTION

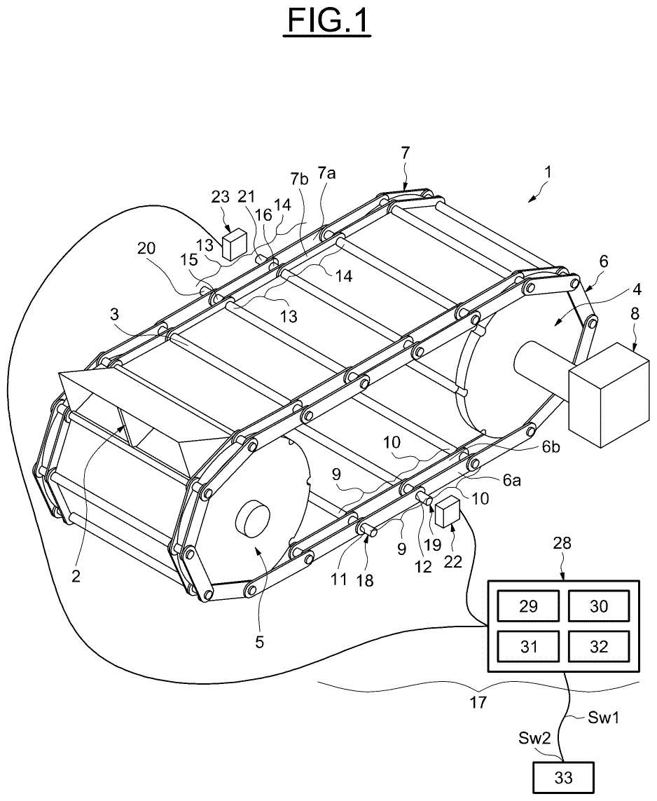

Reference is made to FIG. 1 which represents an example of a twin-chain conveyor 1. The twin-chain conveyor 1 comprises a plurality of buckets 2 connected together with pivoting connections 3. For clarity reason, only one bucket 2 is represented on FIG. 1. The connected series of linked buckets 2 forms a loop extending between a first gear wheel 4 and a second gear wheel 5. The twin-chain conveyor 1 comprises two chains: a first chain 6 and a second chain 7, running in parallel as a matched pair. Each of the chains 6, 7 forming a loop are engaged in the teeth of the two gear wheels 4, 5 to drive the linked buckets 2.

The twin-chain conveyor 1 further comprises driving means 8 to drive each first gear wheel 4. The driving means 8 comprises for example an electric machine such as an electric motor.

The first chain 6 is formed by links 9, 10 connected together by chain pins 11, 12. Each link 9, 10 comprises a first bar 6a and a second bar 6b parallel to the first bar 6a. Each bar 6a, 6b comprises at each end a hole, a first chain pin 11 crossing the holes at a first end of the bars 6a, 6b to connect both bars and a second chain pin 12 crossing the holes at the second end of the bars 6a, 6b to connect both bars. The chain pins 11, 12 of the first chain 6 are identical.

The second chain 7 is formed by links 13, 14 connected together by chain pins 15, 16. Each link 13, 14 comprises a first bar 7a and a second bar 7b parallel to the first bar 7a. Each bar 7a, 7b comprises at each end a hole, a first chain pin 15 crossing the holes at a first end of the bars 7a, 7b to connect both bars and a second chain pin 16 crossing the holes at the second end of the bars 7a, 7b to connect both bars. The chain pins 15, 16 of the second chain 7 are identical.

The twin-chain conveyor 1 further comprises a device 17 for determining the elongation of the two first and second chains 6, 7 running in parallel as a matched pair. The device 17 comprises a first target element 18 arranged at a first end of the first chain pin 11 of the first chain 6, a second target element 19 arranged at the first end of the second chain 12 pin of the first chain 6, a first target element 20 arranged at a first end of the first chain pin 15 of the second chain 7, and a second target element 21 arranged at the first end of the second chain pin 16 of the second chain 7. The first ends of the first chain pins 11, 15 and the first ends of the second chain pins 12, 16 may be on the same side of the chains 6, 7 or on different sides of the chains 6, 7.

The device 17 further comprises a first sensor 22 associated with the first chain 6 and configured to detect the passage of the first target element 18 and the second target element 19, and a second sensor 23 corresponding to the second chain 7 and configured to detect the passage of the first target element 20 and the second target element 21, when the chains 6, 7 are driven by the driving means 8 of the twin-chain conveyor 1.

The sensors 22, 23 are mounted laterally on the outside of the corresponding chains 6, 7. The sensors 22, 23 laterally face the corresponding chains 6, 7. The sensors 22, 23 are fixed relative to the corresponding chains 6, 7.

In this example, the first target element 18 of the first chain pin 11 of the first chain 6 comprises a target comprising a first magnet insert 24, the second target element 19 of the second chain pin 12 of the first chain 6 comprises a target comprising a second magnet insert 25, the first target element 20 of the first chain pin 15 of the second chain 7 comprises a target comprising a third magnet insert 26, and the second target element 21 of the second chain pin 16 of the second chain 7 comprises a target comprising a fourth magnet insert 27. In the illustrated example, the sensors 22, 23 are Hall effect sensors.

In the illustrated example, the target elements 18, 19, 20, 21 and the sensors 22, 23 use magnetic technology. Alternatively, the target elements 18, 19, 20, 21 and the sensors 22, 23 may use any other suitable technology than magnetic technology.

For example, in another embodiment, the first target elements 18, 20 of the first chain pins 11, 15 of both chains 6, 7 may comprise first reflective devices, the second target elements 19, 21 of the second chain pins 12, 16 of both chains 6, 7 may comprise second reflective devices and the sensors 22, 23 may comprise a laser.

The device 17 further comprises a processing module 28 comprising first determining means 29, second determining means 30, third determining means 31, and warning means 32. The first, second and third determining means and the warning means may comprise a programmable hardware component such as a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor. The first determining means 29, second determining means 30, third determining means 31, and warning means 32 are described as separate elements but could be implemented, for example, in a single computer processor.

The first determining means 29 are configured to determine, for the first chain 6, a reference duration Dref1 between a first instant of passage of the first target element 18 arranged at a first chain pin 11 in front of the first magnetic sensor 22 and a second instant of passage of the second target element 19 arranged at a second chain pin 12 in front of the first magnetic sensor 22.

The first determining means 29 are also configured to determine, for the second chain 7, a reference duration Dref2 between a first instant of passage of the first target element 20 arranged at a first chain pin 15 in front of the second magnetic sensor 23 and a second instant of passage of the second target element 21 arranged at a second chain pin 16 in front of the second magnetic sensor 23.

As exposed in the following, the reference duration Dref1, Dref2 is determined during an initialization step S1 following the arrangement of the chains 6, 7 in the twin-chain conveyor 1 when the chains 6, 7 are driven by driving means 8 of the twin-chain conveyor 1 at a predetermined speed. During the initialization step, the chains 6, 7 are new (not worn).

The first determining means 29 are further configured to determine for the first chain 6, a first duration D1 between a third instant of passage of the first target element 18 arranged at the first chain pin 11 in front of the first sensor 22 and a fourth instant of passage of the second target element 19 arranged at the second chain pin 12 in front of the first sensor 22.

The first determining means 29 are also configured to determine for the second chain 7, a first duration D2 between a third instant of passage of the first target element 20 arranged at the first chain pin 15 in front of the second sensor 23 and a fourth instant of passage of the second target element 21 arranged at the second chain pin 16 in front of the second sensor 23.

The first durations D1, D2 are determined during a conveying step S2 following the initialization step S1, when the twin-chain conveyor 1 conveys material at the predetermined speed.

As the value of the elongation of each chain 6, 7 is determined by measuring the distance between two chain pins 11, 12, 15, 16 and comparing the measured distance with the distance of a new chain, when the chains 6, 7 are driven at a predetermined constant speed, the reference durations Dref1, Dref2 are representative of the distance between two chain pins 11, 12, 15, 16 when the chains 6, 7 are new and the first durations D1, D2 are representative of the distance between two chain pins 11, 12, 15, 16 of the chains 6, 7 during a conveying step S2.

For each chain 6, 7, the distance between two chain pins 11, 12, 15, 16 of the chains 6, 7 is equal to the reference duration Dref1, Dref2 multiplied by the predetermined speed and the distance between two chain pins 11, 12, 15, 16 of the chains 6, 7 during a conveying step S2 is equal to the first duration D1, D2 multiplied by the predetermined speed.

The second determining means 30 are configured to determine the value of the elongation VE1, VE2 of the chains 6, 7 from the first duration D1, D2 and the reference duration Dref1, Dref2.

The value of the elongation VE1 of the first chain 6 is equal to:

$$VE 1 = \frac{D 1 - Dref 1}{Dref 1}$$

The value of the elongation VE2 of the second chain 7 is equal to:

$$VE 2 = \frac{D 2 - Dref 2}{Dref 2}$$

The third determining means 31 are configured to compare the values of the elongation VE1, VE2 of the first and second chains 6, 7. The comparison of the values of the elongation of the first and second chains makes it possible to evaluate the state of the twin-chain conveyor 1 and in particular to know the differential elongation between the value of the elongation VE1 of the first chain 6 and the value of the elongation VE2 of the second chain 7.

The warning means 32 are configured to deliver a warning signal to warn of possible failures of the double-chain conveyor 1 when a differential elongation between the first and second chains is detected. Indeed, when the differential elongation is equal to a predetermined warning value, the warning signal is delivered by the warning means 32. This warning makes it possible to prevent a breakage of the twin-chain conveyor 1 due to the differential elongation of the chains 6, 7.

The warning signal is for example delivered to a human machine interface to warn an operator, for example a warning light. The warning signal may be delivered to a processing unit (not represented) for further processing. For example, a first predetermined warning value and a second predetermined value bigger than the first predetermined value are defined. The first predetermined warning value may be representative to a degree of wear needing to plan maintenance operation of the chains 6, 7 and the second predetermined warning value may be representative to a degree of wear needing the replacement of the chains 6, 7.

In one embodiment, the warning means 32 are also configured to deliver a chain alert to warn for potential failures of the twin-chain conveyor 1 when the determined value VE1, VE2 of the elongation of at least one of the first and second chains 6, 7 is equal to at least one predetermined warning value of the elongation of the first or second chains 6, 7. This warning signal allows to warn the value of the elongation of each chain 6, 7 individually in addition to the comparison of the value of elongation between the two chains 6, 7. The chain alert is for example delivered to a human machine interface to warn an operator, for example a warning light. The chain alert may be delivered to a processing unit (not represented) for further processing.

For example, a first predetermined alert value and a second predetermined alert value greater than the first predetermined alert value are defined. The first predetermined alert value may be representative of a degree of wear needing to plan maintenance operation of at least one of the chains 6, 7 and the second predetermined alert value may be representative of a degree of wear needing the replacement of at least one of the chains 6, 7. The first predetermined alert value may be equal to 2% and the second predetermined alert value may be equal to 3%.

The evaluation of the state of the elongation of the chains 6, 7 and in particular of the differential elongation of the chains 6, 7 makes it possible to know whether it is necessary to repair one of the chains 6, 7, to repair both chains 6, 7, to replace one of the chains 6, 7 or to replace both chains 6, 7.

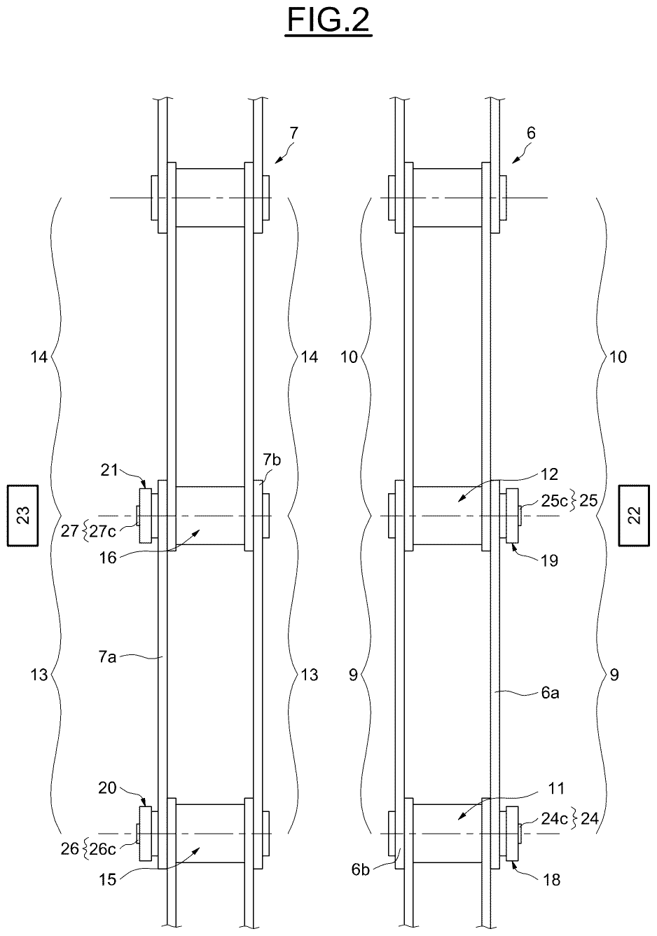

FIG. 2 schematically illustrates a partial view of an example of the chains 6, 7 running in parallel matched pairs of the twin-chain conveyor 1. The first chain 6 comprises the links 9, 10. The link 9 comprises the first and second chain pins 11, 12 comprising the first and second target elements 18, 19. In another embodiment, the first and second target elements 18, 19 may be arranged on chain pins of two different links, the chain pins being adjacent. As previously mentioned, the first target element 18 comprises a first magnet insert 24, the second target element 19 comprises a second magnet insert 25, and the first sensor 22 is a Hall effect sensor.

The second chain 7 comprises the links 13, 14. The link 13 comprises the first and second chain pins 15, 16 comprising the first and second target elements 20, 21. In another embodiment, the first and second target elements 20, 21 may be arranged on chain pins of two different links, the chain pins being adjacent. As previously mentioned, the first target element 20 comprises a third magnet insert 26, the second target element 21 comprises a fourth magnet insert 27, and the second sensor 23 is a Hall effect sensor.

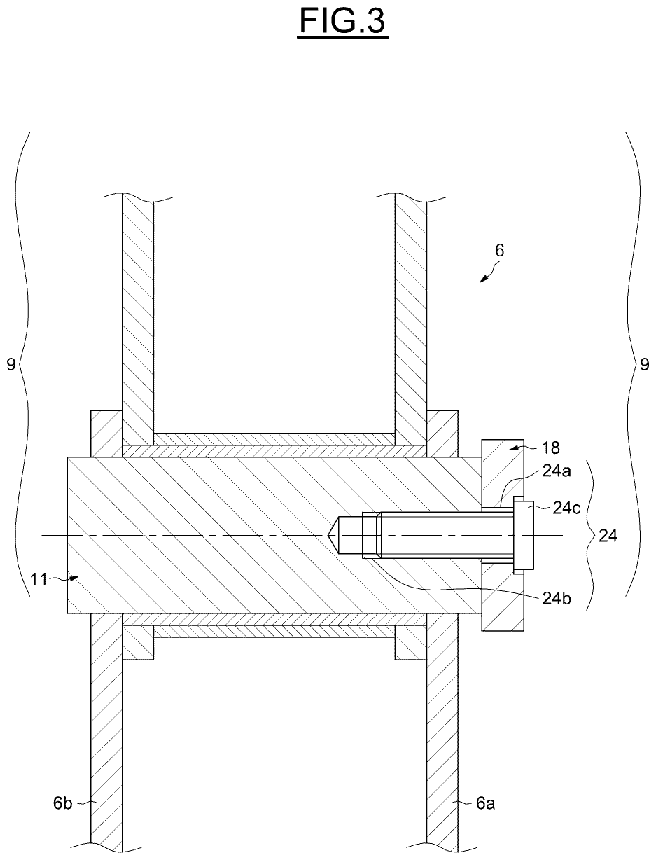

As the first, the second, the third and the fourth magnet inserts 24, 25, 26, 27 are identical, FIG. 3 illustrates schematically a longitudinal cross section of the first chain pin 11 of the first chain 6. The configuration is identical for the second chain 7 as well as for the second chain pin 12 of the first chain 6. The first magnet insert 24 is arranged at the first end of the first chain pin 11 of the first chain 6. The first magnet insert 24 may be circular. The first magnet insert 24 comprise a through hole 24a. The first end of the first chain pin 11 of the first chain 6 comprises a tapered hole 24b. A screw 24c passes through the through hole 24a of the first magnet insert 24 and is engaged in the tapered hole 24b of the first end of the first chain pin 11 to maintain the first magnet insert 24 on the first end of the first chain pin 11 of the first chain 6.

Similarly, the second magnet insert 25 of the first chain 6 may be circular and may comprises a through hole (not represented), a screw 25c passing through the through hole of the second magnet insert 25 and being engaged in a tapered hole (not represented) of the first end of the second chain pin 12 to maintain the second magnet insert 25 on the first end of the second chain pin 12 of the first chain 6.

Similarly, the third magnet insert 26 of the second chain 7 may be circular and may comprises a through hole (not represented), a screw 26c passing through the through hole of the third magnet insert 26 and being engaged in a tapered hole (not represented) of the first end of the first chain pin 15 of the second chain 7 to maintain the third magnet insert 26 on the first end of the first chain pin 15 of the second chain 7.

Similarly, the fourth magnet insert 27 of the second chain 7 may be circular and may comprises a through hole (not represented), a screw 27c passing through the through hole of the fourth magnet insert 27 and being engaged in a tapered hole (not represented) of the first end of the second chain pin 16 of the second chain 7 to maintain the fourth magnet insert 27 on the first end of the second chain pin 16 of the second chain 7.

The first, second, third and fourth magnet inserts 24, 25, 26, 27 may be maintained on the corresponding chain pins 11, 12, 15, 16 of the corresponding chain 6, 7 by other means, for example the first, second, third, fourth magnet inserts 24, 25, 26, 27 may be glued on the corresponding chain pins 11, 12, 15, 16 of the corresponding chain 6, 7.

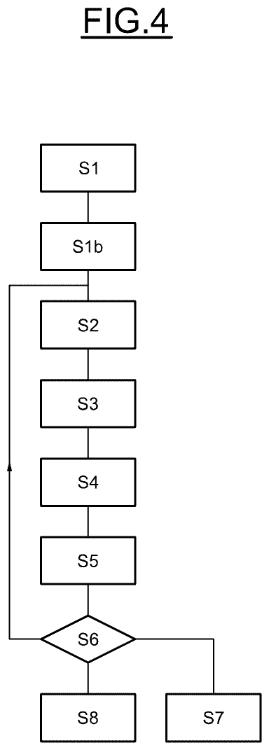

FIG. 4 illustrates schematically an example of a method for determining the elongation of the chains 6, 7. The method implements the device 17.

During an initialization step S1 following the arrangement of the chains 6, 7 in the twin-chain conveyor 1, when the chains 6, 7 are driven by the driving means 8 at the predetermined speed, the first determining means 29 detect the first instant of passage of the first target element 18 arranged at a first end of the first chain pin 11 of the first chain 6 in front of the first sensor 22 from a signal delivered by the first sensor 22 when the first target element 18 is in front of the first sensor 22.

The first determining means 29 also detect the first instant of passage of the first target element 20 arranged at a first end of the first chain pin 15 of the second chain 7 in front of the second sensor 23 from a signal delivered by the second sensor 23 when the first target element 20 is in front of the second sensor 23.

The twin-chain conveyor 1 does not convey material during the initialization step S1.

Further during the initialization step S1, the first determining means 29 detect the second instant of passage of the second target element 19 arranged at a first end of the second chain pin 12 of the first chain 6 in front of the first sensor 22 from a signal delivered by the first sensor 22 when the second target element 19 is in front of the first sensor 22. The first determining means 29 also detect the second instant of passage of the second target element 21 arranged at a first end of the second chain pin 16 of the second chain 7 in front of the second sensor 23 from a signal delivered by the second sensor 23 when the second target element 21 is in front of the second sensor 23. When the first determining means 29 have detected the first and second instants, the first determining means 29 determine the reference duration Dref1, Dref2 in a step S1b.

The predetermined speed is equal to the speed of the twin-chain conveyor 1 when the twin-chain conveyor 1 conveys material. The reference duration Dref1, Dref2 is the duration between the first and the second instants at the predetermined speed when the chains 6, 7 are new, not yet worn.

During a conveying step S2, following the initialization step S1, wherein the twin-chain conveyor 1 conveys material at the predetermined speed, the first determining means detect the third instant of passage of the first target element 18 arranged at a first end of the first chain pin 11 of the first chain 6 in front of the first sensor 22 from a signal delivered by the first sensor 22 when the first target element 18 is in front of the first sensor 22.

The first determining means 29 also detect the third instant of passage of the first target element 20 arranged at a first end of the first chain pin 15 of the second chain 7 in front of the second sensor 23 from a signal delivered by the second sensor 23 when the first target element 20 is in front of the second sensor 23. Further during the conveying step S2, the first determining means 29 detect the fourth instant of passage of the second target element 19 arranged at a first end of the second chain pin 12 of the first chain 6 in front of the first sensor 22 from a signal delivered by the first sensor 22 when the second target element 19 is in front of the first sensor 22. The first determining means 29 also detect the fourth instant of passage of the second target element 21 arranged at a first end of the second chain pin 16 of the second chain 7 in front of the second sensor 23 from a signal delivered by the second sensor 23 when the second target element 21 is in front of the second sensor 23.

When the first determining means 29 have detected the third and fourth instants, the first determining means 29 determine the first duration D1, D2 in a step S3. In a calculating step S4, the second determining means 30 determine the value of the elongation VE1, VE2 of the chains 6, 7 from the first duration D1, D2 and the reference duration Dref1, Dref2 according to equations and.

In a comparing step S5, when the values of the elongation VE1, VE2 of the chains 6, 7 are determined by the second determining means 30, the third determining means 31 determine the differential elongation between the first and second chains 6, 7, established by the difference between the value of the elongation VE1 of the first chain 6 and the value of the elongation VE2 of the second chain 7.

If the differential elongation between the first and second chains 6, 7 is less than the first predetermined warning value (step S6), the method goes back to step S2. If the differential elongation between the first and second chains 6, 7 is equal or bigger than the first predetermined warning value (step S6) and smaller than the second predetermined warning value, in a step S7, the warning means 32 deliver a first warning signal Sw1 (FIG. 1) to warn for potential failures of the twin-chain conveyor 1.

The human machine interface 33 receives the first warning signal Sw1 and may warn the operator that the differential elongation between the first and second chains 6, 7 is at least equal to the first predetermined warning value and that maintenance operation of at least one of the first and second chains 6, 7 should be planned. In one embodiment, the warning means 32 deliver a chain alert to warn what chain 6, 7 need a maintenance operation. That can be the first chain 6 or the second chain 7 or both first and second chains 6, 7.

If the differential elongation between the first and second chains 6, 7 is equal or greater than the second predetermined warning value (step S6), in a step S8, the warning means 32 deliver a second warning signal Sw2 (FIG. 1) to warn for potential failures of the twin-chain conveyor 1.

The human machine interface 33 receives the second warning signal Sw2 and may warn the operator that the differential elongation between the first and second chains 6, 7 is at least equal to the second predetermined warning value and that at least one of the first and second chains 6, 7 should be replaced. In one embodiment, the warning means 32 deliver a chain alert to warn what chain 6, 7 should be replaced. That can be the first chain 6 or the second chain 7 or both first and second chains 6, 7.

After step S7, the method may go back to step S2. After step S8, the method may stop or go back to step S2.

The device 17 may comprise others magnetic sensors so that each magnetic sensor is configured to detect the passage of one of the first and second magnetic inserts 24, 25, 26, 27.

The method allows automated continuous determination of the elongation of the chains 6, 7 to predict the wear of the chains 6, 7 without requiring physical measurement of the chains 6, 7 so that the twin-chain conveyor 1 does not need to be shut down and operatives do not need to physically measure the chains 6, 7. The prediction of the wear of the chains 6, 7 enables maintenance for the chains 6, 7 to be planned, thereby reducing risk of failure of the chains 6, 7 and reducing risk of breakage of the chains 6, 7 which may lead to damaging the twin-chain conveyor 1 or injuring operatives.

The establishment of the differential elongation between the first and second chains 6, 7 makes it possible to evaluate the state of the twin-chain conveyor 1 and to know whether it is necessary to repair at least one of the chains 6, 7 or to replace one of the chains 6, 7.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods and devices for determining chain elongation of a pair of chains.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

1. A method for determining an elongation of a first chain and a second chain of a matched pair of parallel chains of a twin-chain conveyor, the method comprising:
performing an initialization step comprising:
driving the first and second chains at a predetermined speed,
detecting a first instant of passage of a first target element arranged at a first end of a first chain pin of the first chain in front of a first sensor,
detecting a first instant of passage of a first target element arranged at a first end of a first chain pin of the second chain in front of a second sensor,
detecting a second instant of passage of a second target element arranged at a first end of a second chain pin of the first chain in front of the first sensor,
detecting a second instant of passage of a second target element arranged at a first end of a second chain pin of the second chain in front of the second sensor,
determining a duration between the first instant of passage of the first target element of the first chain in front of the first sensor and the second instant of passage of the second target element of the first chain in front of the first sensor as a first reference duration,
determining a duration between the first instant of passage of the first target element of the second chain in front of the second sensor and the second instant of passage of the second target element of the second chain in front of the second sensor as a second reference duration,
after performing the initializing step, performing a conveying step comprising:
driving the first and second chains at the predetermined speed while a material is conveyed by the twin-chain conveyor,
detecting a third instant of passage of the first target element of the first chain in front of the first sensor,
detecting a third instant of passage of the first target element of the second chain in front of the second sensor,
detecting a fourth instant of passage of the second target element of the first chain in front of the first sensor,
detecting a fourth instant of passage of the second target element of the second chain in front of the second sensor, and
determining a duration between the third instant of passage of the first target element of the first chain in front of the first sensor and the fourth instant of passage of the second target element of the first chain in front of the first sensor as a third reference duration,
determining a duration between the third instant of passage of the first target element of the second chain in front of the second sensor and the fourth instant of passage of the second target element of the second chain in front of the second sensor as a fourth reference duration,
determining a difference between the third duration and the first duration as a first degree of elongation of the first chain,
determining a difference between the fourth duration and the second duration as a second degree of elongation of the second chain, and
determining a differential elongation equal to a difference between the first degree of elongation and the second degree of elongation.

2. The method according to claim 1,
wherein the twin-chain conveyor does not convey material during the initialization step.

3. The method according to claim 2,
wherein first chain pin and the second chain pin are immediately adjacent.

4. The method according to any one of claim 2,
calculating a first elongation value VE1 according to the formula:
$$VE 1 = \frac{D 1 - Dref 1}{Dref 1}$$
wherein D1 is the third duration, Dref1 is the first duration, and
calculating a second elongation value VE2 according to the formula:
$$VE 2 = \frac{D 2 - Dref 2}{Dref 2}$$
where D2 is the fourth duration and Dref2 is the second duration.

5. The method according to claim 4,
including generating a first warning signal when VE1 and/or VE2 is equal to a first predetermined warning value.

6. The method according to claim 4,
including generating a first warning signal when the differential elongation is equal to a first predetermined warning value

7. The method according to claim 1,
wherein the first target element of the first chain pin of the first chain comprises a first magnet insert, the second target element of the second chain pin of the first chain comprises a second magnet insert, the first target element of the first chain pin of the second chain comprises a third magnet insert, the second target element of the second chain pin of the second chain comprises a fourth magnet insert, and the sensors are Hall effect sensors.

8. The method according to claim 7,
wherein the first and second magnets inserts each comprise a through hole, a screw passing through the through hole of the first and second magnets inserts and being engaged in a tapered hole of the first end of the first and second chain pins, and the third and fourth magnets inserts each comprise a through hole, a screw passing through the through hole of the third and fourth magnets inserts and being engaged in a tapered hole of the first end of the first and second chain pins.

9. An assembly for determining an elongation of a first chain and a second chain of a matched pair of parallel chains of a twin-chain conveyor, the assembly comprising:
a first target element arranged at a first end of a first chain pin of the first chain,
a first target element arranged at a first end of a first chain pin of the second chain,
a second target element arranged at a first end of a second chain pin of the first chain,
second target element arranged at a first end of a second chain pin of the second chain,
a first sensor associated with the first chain and configured to detect the passage of the first target element and the second target element and a second sensor associated with the second chain and configured to detect the passage of the first target element and the second target element, when the chains are driven by driving means of the twin-chain conveyor,
first determining means configured to determine, for each of the first and second chains, reference duration between a first instant of passage of the first target elements in front of the sensors and a second instant of passage of the second target elements in front of the sensors and a first duration between a third instant of passage of the first target elements in front of the sensors and a fourth instant of passage of the second target elements in front of the sensors,
second determining means configured to determine the value of the elongation (VE1, VE2) of each of the first and second chains from the associated first duration and the associated reference duration determined by the first determining means, and
third determining means configured to compare the value of the elongation (VE1) of the first chain with the value of the elongation (VE2) of the second chain and establishing a differential elongation.

10. The assembly according to claim 8,
further comprising warning means configured to deliver a warning signal to warn for potential failures of the twin-chain conveyor when the differential elongation is equal to at least one predetermined warning value and to deliver a chain alert when at least one of the determined value of the elongation (VE1, VE2) of the chains is equal to at least one predetermined alert value of the elongation of the first or second chains.

11. A twin-chain conveyor comprising:
a first chain,
a second chain parallel to the first chain, and
an assembly according to claim 9.
